(19) United States
(12) Patent Application Publication
(10) Pub. No.: US 2019/0207503 A1
(43) Pub. Date: Jul. 4, 2019

(54) MOTOR FOR STIRLING COOLER HAVING QUADRATURE MAGNETS

(71) Applicant: Dexter Magnetic Technologies, Inc., Elk Grove Village, IL (US)

(72) Inventors: Christopher A. Ras, St. Charles, IL (US); Richard Stelter, Elk Grove Village, IL (US)

(21) Appl. No.: 16/228,886

(22) Filed: Dec. 21, 2018

Related U.S. Application Data
(60) Provisional application No. 62/612,785, filed on Jan. 2, 2018.

(51) Int. Cl. H02K 35/02; H02K 33/16; H02K 7/18; H02K 41/035

(52) U.S. Cl. CPC H02K 35/02; H02K 33/16; F02G 1/043; H02K 41/0356; H02K 7/1876

(57) ABSTRACT

A voice-coil type cooler motor magnet assembly includes at least one radially polarized ring magnet disposed on a ferromagnetic hub. At least one quadrature magnet is disposed on the hub on each longitudinal side of the at least one ring magnet. Each quadrature magnet is polarized in a direction toward the at least one ring magnet. The hub, the at least one radially polarized ring magnet and the quadrature magnets are disposed in a ferromagnetic outer housing.

### CROSS REFERENCE TO RELATED APPLICATIONS

Priority is claimed from U.S. Provisional Application No. 62/612,785 filed on Jan. 2, 2018 and incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of electric motors. More specifically, the disclosure relates to magnet structures for a motor in a Stirling cooler.

Stirling cooler motors known in the art consist of a dual-opposed-piston linear compressor that generates an alternating pressure waveform to drive a displacer within a dewar flask. An example embodiment of a Stirling cooler including a “voice coil” type motor is shown schematically in FIG. 1. A wire coil called a “voice coil” 21 is movably disposed inside a magnet assembly 20, to be explained further below with reference to FIG. 3. The voice coil 21 and magnet assembly form a voice coil linear actuator which provides mechanical energy to operate a piston (or pistons) and a displacer.

Within the compressor, the voice coil linear actuator (so named because of similarity of its design to a loudspeaker voice coil) provides the force to operate the pistons for the compression. Alternating current flowing in coil windings in the voice coil 21 acts in concert with magnetic flux within an air gap of the magnet assembly 20 to convert electrical energy in the voice coil 21 to mechanical energy. The principle of operation of the voice coil linear actuator is the Lorentz force exerted on the voice coil by the static magnetic field from the magnet assembly. The Lorentz force F is given by the equation shown below:

F=ILB

where the I is the current in the voice coil winding; L is the length of the voice coil winding and B is the flux density of the static magnetic field from a magnet assembly disposed proximate the voice coil winding.

To improve the efficiency of the motor design, the power consumption and the volume of the motor should be optimized. Much effort toward improving the cooler motor design has been directed toward increasing the flux density of the static magnetic field B. An example embodiment of a magnet assembly for a Stirling cooler motor known in the art is shown in FIG. 2. The magnet assembly 10 includes a cylindrically shaped, ferromagnetic hub 12 and a radially polarized, ring shaped magnet 16 disposed on the exterior of the hub 12. The hub 12 and ring magnet 16 are disposed in an outer housing 14, which may also be made from a ferromagnetic material.

### SUMMARY

A voice-coil type cooler motor magnet assembly according to one aspect of the present disclosure includes at least one radially polarized ring magnet disposed on a ferromagnetic hub. At least one quadrature magnet is disposed on the hub on each longitudinal side of the at least one ring magnet, each quadrature magnet polarized in a direction toward the at least one ring magnet. The hub, the at least one radially polarized ring magnet and each quadrature magnet are disposed in a ferromagnetic outer housing.

In some embodiments, each quadrature magnet is polarized at an angle with respect to the ring magnet such that a magnetic field flux density in a gap between the hub and the outer housing is maximized.

Some embodiments further comprise a thermal demagnetization shunt disposed between each quadrature magnet and the at least one ring magnet

Other aspects and possible advantages will be apparent from the description and claims that follow.

### BRIEF DESCRIPTION OF THE DRAWINGS

FIG. 1 shows a schematic diagram of a voice coil, linear actuator operated Stirling cooler.

FIG. 2 shows a Stirling cooler motor magnet assembly known in the art.

FIG. 3 shows a Stirling cooler motor magnet assembly according to the present disclosure.

FIGS. 4 and 4A show a cut away view and a cross-sectional view, respectively, of the embodiment of FIG. 3 to illustrate field flux density reduction from a quadrature magnet.

FIGS. 5 and 5A show a cut away view and a cross-sectional view, respectively, of the embodiment of FIG. 3 with a thermal demagnetization shunt between the ring magnet and one of the quadrature magnets to illustrate field flux density preservation using the thermal demagnetization shunt in some embodiments.

FIG. 6 shows a longitudinal magnetic field flux density profile for the embodiment of FIG. 4 contrasted with the embodiment shown in FIG. 5.

### DETAILED DESCRIPTION

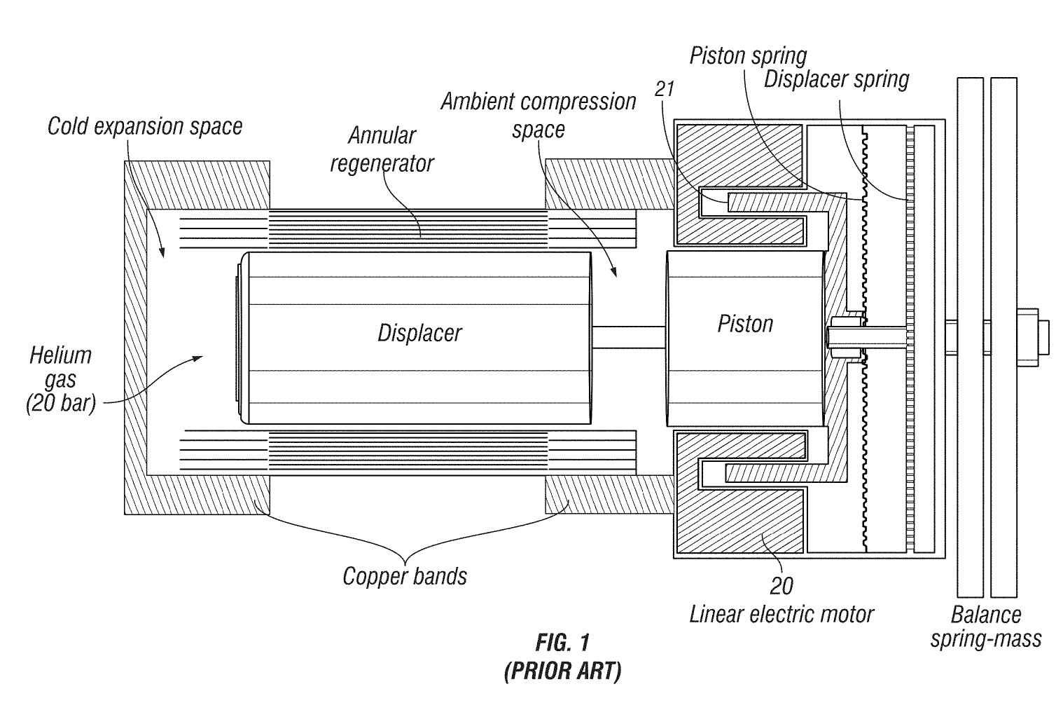

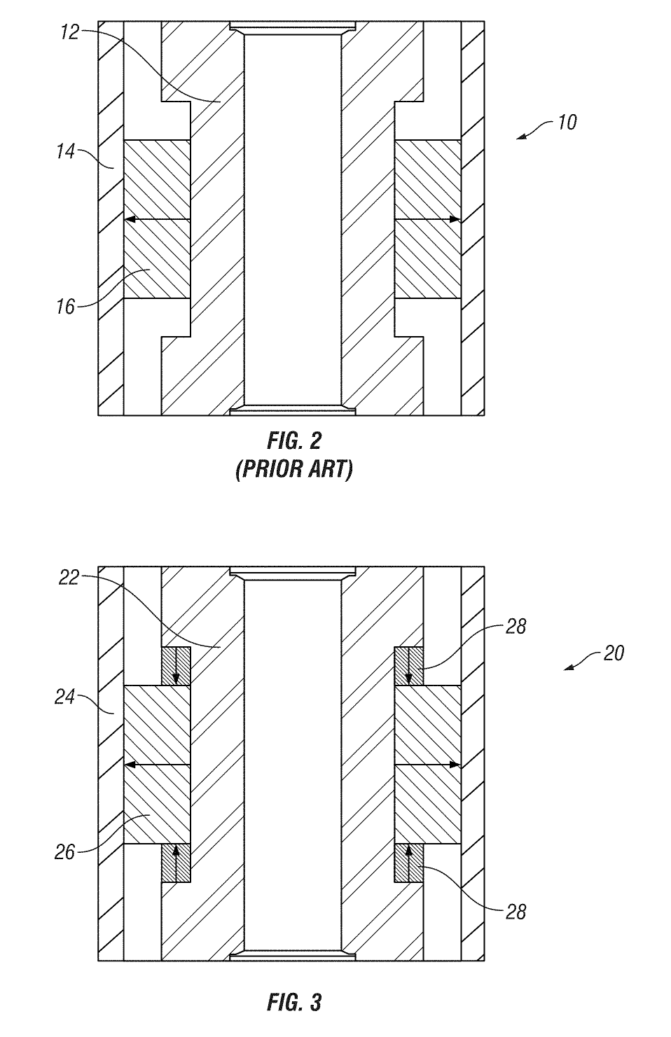

An example embodiment of a Stirling cooler having a motor according to the present disclosure is shown schematically in FIG. 1. A wire coil, called a “voice coil”, 21 is movably disposed inside a magnet assembly 20, to be explained further below with reference to FIG. 3. The voice coil 21 and the magnet assembly 20 cooperate magnetically when electric current passes through the voice coil 21 to perform as a voice coil linear actuator. Such actuator may provide mechanical energy to operate a piston (or pistons) and a displacer.

FIG. 3 shows an example embodiment of a magnet assembly 20 according to the present disclosure usable in a Stirling cooler motor. The magnet assembly 20 may include, in the present example embodiment, an annular, cylindrically shaped hub 22 and a radially polarized, ring shaped magnet 26 disposed on the exterior of the hub 22. The hub 22 and the ring shaped magnet 26 may be disposed in an outer housing 24. A space along the longitudinal dimension of the hub 22 between each longitudinal end of the hub 22 and a longitudinal edge of the ring shaped magnet 26 may have disposed therein a quadrature magnet 28. Each quadrature magnet 28 in the present example embodiment may be in the form of an annular ring disposed on the hub 22 and each such quadrature magnet 28 may be polarized along the longitudinal direction of the annular ring. Each quadrature magnet 28 may be polarized in a direction toward the ring shaped magnet 26 as shown by the arrows on each quadrature magnet 28 as shown in FIG. 3. The particular quadrature magnet 28 polarization direction may be optimized as explained further below. Based on the principle of vector superposition, the magnetic flux from the quadrature magnets 28 is added to the magnetic flux from the ring shaped magnet 26, resulting in increased magnetic field flux density in an air gap between the outer housing 24 and the inner hub 22 at the longitudinal end of the hub 22 on each side of the ring shaped magnet 26. Although only one ring shaped magnet and two quadrature magnets are shown in FIG. 3, some embodiments may have two or more ring magnets and two or more separate magnets for each quadrature magnets.

Although the quadrature magnets 28 are shown in FIG. 3 as being polarized perpendicularly to the polarization direction of the ring magnet 26, in some embodiments the quadrature magnets 28 may be polarized at a selected angle with respect to the polarization direction of the ring magnet 26; the selected angle may be any value from zero to 90o with respect to the polarization angle of the ring magnet 26. The selected polarization angle may be optimized such that the quadrature magnets 28 provide a maximum increase in the magnetic field flux density in the air gap.

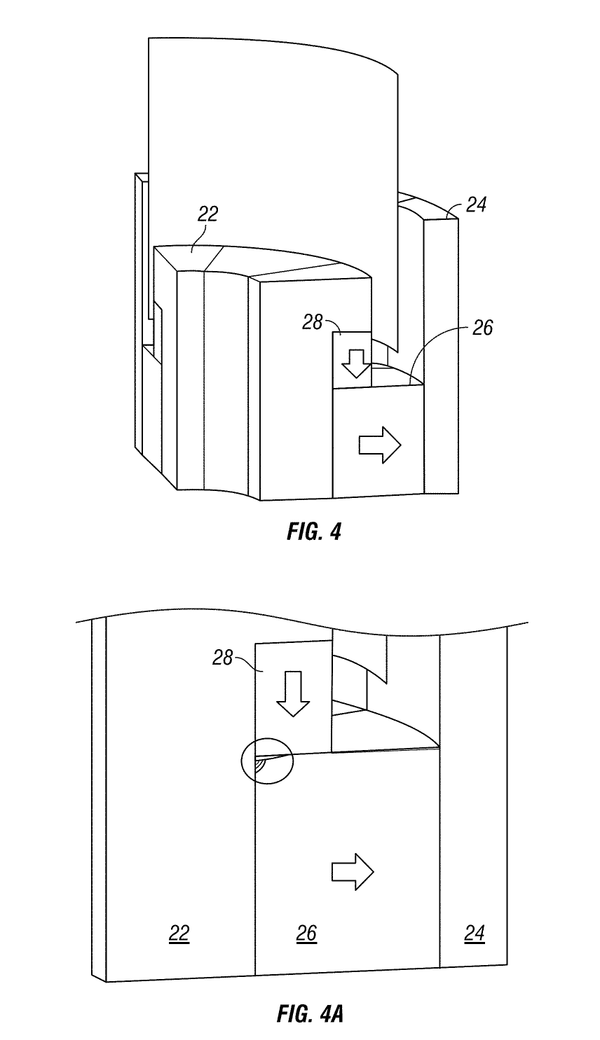

Referring to FIG. 4 and FIG. 4A, the embodiment shown in FIG. 3 may be susceptible to magnetic field flux density reduction below that induced by the ring shaped magnet 26 in certain portions of space around the ring shaped magnet 26 and the quadrature magnets 28 (only one is illustrated in FIG. 4 for clarity). FIG. 4 is a partial cut away view of the embodiment shown in and explained with reference to FIG. 3, and FIG. 4A is a partial cross-sectional view of the embodiment shown in and explained with reference to FIG. 3. At the position indicated in FIG. 4A, a field polarization direction reversal exists, such that the total static magnetic field flux density close to the position shown may be reduced. In the embodiment shown in FIG. 4A, calculated magnetic field amplitude values were nearly 30 kilogauss (kG).

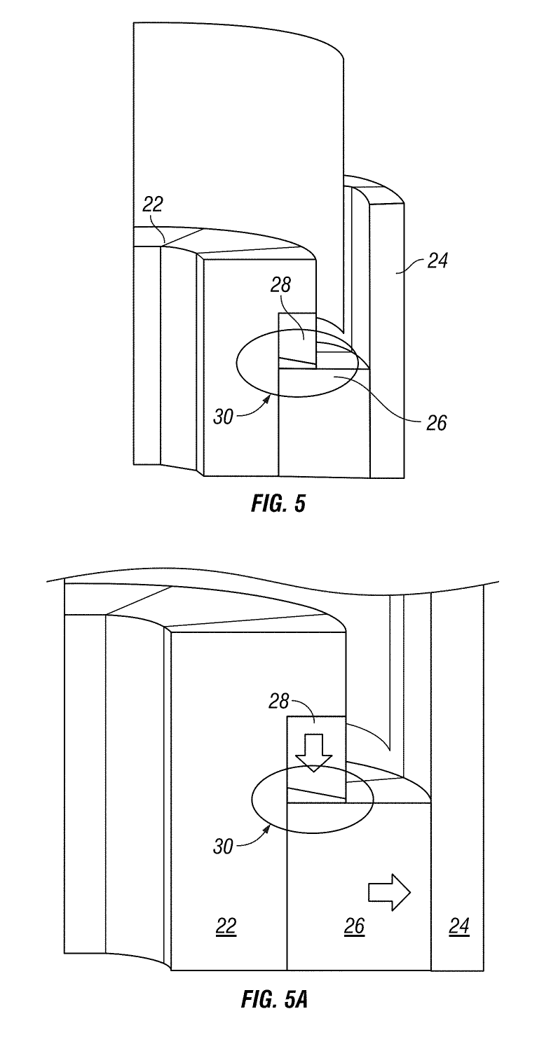

In some embodiments, and referring to FIGS. 5 and 5A, a side of the quadrature magnets 28 (only one shown in FIGS. 5 and 5A for clarity) proximate the ring shaped magnet 26 may be tapered as shown to enable insertion of a thermal demagnetization shunt 30 in the space created by tapering a side of the quadrature magnets 28. Referring to FIG. 5A, by using the thermal demagnetization shunt 30, the field polarization direction reversal is eliminated; in the embodiment shown, the calculated minimum magnetic field flux density in the same position as shown in FIG. 4A is positive 5 kG.

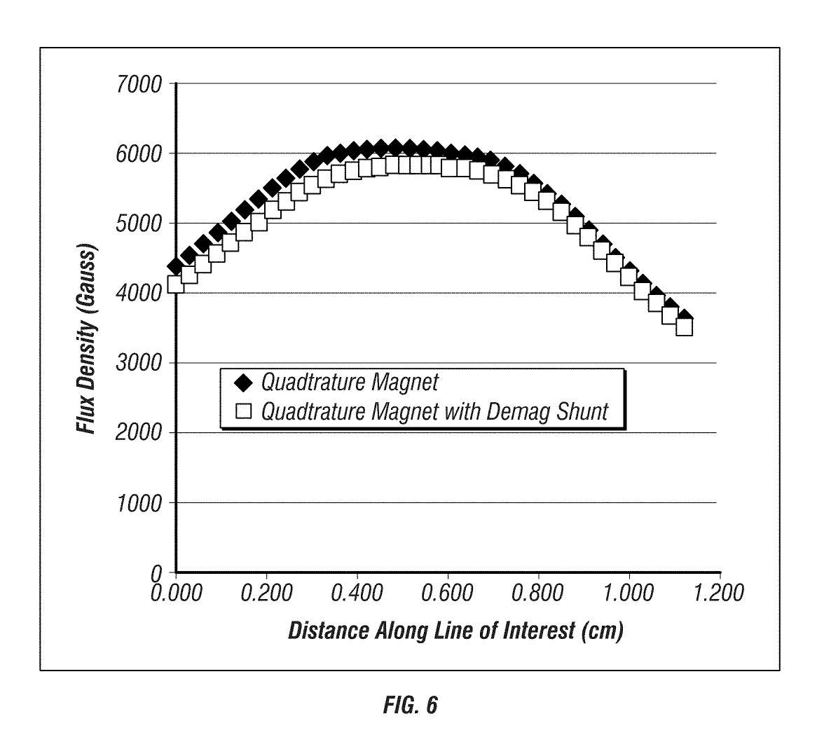

FIG. 6 shows a graph comparing the magnetic field flux density with respect to longitudinal position along the ring magnet (26 in FIG. 4 and FIG. 5) of the embodiment shown in FIG. 4 (indicated by ♦ symbols) and the embodiment shown in FIG. 5 including tapered quadrature magnets and thermal demagnetization shunts as shown (indicated by ▪ symbols). The magnetic field flux density distribution of the embodiment shown in FIG. 5 correlates 97% to the field flux density distribution of the embodiment shown in FIG. 4.

A magnet assembly for a Stirling cooler motor according to the present disclosure may provide reduced power consumption and reduced motor size for any particular heat capacity of such a cooler.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A voice-coil type motor magnet assembly for a cooler, comprising:
at least one radially polarized ring magnet disposed on a ferromagnetic hub;
at least one quadrature magnet disposed on the hub on each longitudinal side of the at least one ring magnet, each quadrature magnet polarized in a direction toward the at least one ring magnet; and
wherein the hub, the at least one radially polarized ring magnet and each quadrature magnet are disposed in a ferromagnetic outer housing.

2. The magnet assembly of claim 1 wherein each quadrature magnet is polarized at an angle with respect to the ring magnet such that a magnetic field flux density in a gap between the hub and the outer housing is maximized.

3. The magnet assembly of claim 1 further comprising a thermal demagnetization shunt disposed between each quadrature magnet and the at least one ring magnet
